(19) United States
(12) Patent Application Publication
(10) Pub. No.: US 2007/0019658 A1
(43) Pub. Date: Jan. 25, 2007

(54) System for communicating call status information in an internet protocol network

(75) Inventors: Sang-Joon Park, Anyang-si (KR); Joon-Sung Chun, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/311,368

(22) Filed: Dec. 20, 2005

(30) Foreign Application Priority Data
Jul. 19, 2005 (KR) 10-2005-0065480

(51) Int. Cl. H04L 12/66; H04L 12/56; H04L 12/28

(52) U.S. Cl. 370/410; 370/352

(57) ABSTRACT

A communication terminal includes a controller to, when a call set up between the communication terminal and a second communication terminal in an internet protocol network is released, encapsulate in a call release request message call status information relating to at least one status of the call and transmit the call release request message. The communication terminal further includes an output element coupled to the controller to transmit the call release request message. The call release request message includes the call status information and information indicating the call release.

### CLAIM OF PRIORITY

This application makes reference to, incorporates the same herein, and claims all benefits accruing under 35 U.S.C. §119 from an application filed in the Korean Intellectual Property Office on Jul. 19, 2005 and there duly assigned Serial No. 10-2005-0065480.

### BACKGROUND OF THE INVENTION

1. Field of the Invention

The present invention relates generally to a system for communicating call status information in an internet protocol network.

2. Description of the Related Art

In general, SIP, the session initiation protocol, is a protocol for controlling ordinary telephony service calls in order to connect telephones through an Internet protocol (IP) network, and the background of the invention is described in relation to SIP along with its problems. However, similar problems may also arise in other communication systems and/or protocols including but not limited to H.323 and MGCP (media gateway control protocol). RFC (Request for Comments) 2543 has been submitted to Internet engineering task force (IETF) in 1999, and has features such as free phone billing, telephony transmission, caller indentification (ID) and so on. The standard of SIP is a standard of ITU-T (International Telecommunications Union Telecommunications) for multimedia communication in the local area network (LAN) such as Ethernet or the Internet, on which QoS (Quality of Service) is not guaranteed. The SIP is a control protocol of a multimedia session layer or application layer of OSI (Open Systems Interconnection) basic reference model capable of performing setup, modification and termination of calls. Therefore, there is a difference in that, while the former is a fixed standard, the latter is an operational rule (setup of calls, control, charging, etc.) that is continuously made up for in consideration of utility.

A conventional wireless LAN communication system based on the SIP may include a user agent server (UAS) as a transmission SIP wireless LAN terminal, and a user agent client (USC) as a reception SIP wireless LAN terminal, in addition to a SIP server.

If the wireless LAN communication system does not include the SIP server, the transmission SIP wireless LAN terminal may know an address of the reception SIP wireless LAN terminal.

If the transmission SIP wireless LAN terminal does not know the address of the reception SIP wireless LAN terminal, it may make use of the SIP server. Here, the SIP server includes a proxy server, and a redirect server having a database in which IP addresses of the SIP terminals are stored.

In this wireless LAN system having the conventional SIP server, call setup and release processes for media communication between the SIP terminals will be described.

First, in terms of the call setup process, the transmission SIP wireless LAN terminal transmit a “INVITE” message to the reception SIP wireless LAN terminal. At this time, to do so, the transmission SIP wireless LAN terminal may know an IP address of the reception SIP wireless LAN terminal.

If a user using the transmission SIP wireless LAN terminal does not know the IP address of the reception SIP wireless LAN terminal, the SIP server may be used. At this time, it may be made a condition that the IP address of the reception SIP wireless LAN terminal may be registered with the SIP server.

Thus, the transmission SIP wireless LAN terminal may transmit (or route) the “INVITE” message to the SIP server but not necessarily to the reception SIP wireless LAN terminal.

Then, the SIP server may transmit the “INVITE” message received from the transmission SIP wireless LAN terminal to the corresponding reception SIP wireless LAN terminal. At this time, in order to look for a SIP URL (Universal Resource Locator) domain name, DSN (Delivery Status Notification) lookup may be performed. Here, an IP address of the proxy server managing a receiver domain may be determined, and the “INVITE” message transmitted from the transmission SIP wireless LAN terminal may be transmitted to the SIP server.

Subsequently, the SIP server may look for an IP address of the reception SIP wireless LAN terminal in a database using a SIP URL in a Request-URL of the “INVITE” message, and then may transmit the “INVITE” message transmitted from the transmission SIP wireless LAN terminal to the reception SIP wireless LAN terminal. At this time, a Via header indicating the address of the proxy server may be further added to the “INVITE” message that is transmitted to the reception SIP wireless LAN terminal.

Thereafter, the reception SIP wireless LAN terminal may recognize through the Via header encapsulated in the “INVITE” message that the “INVITE” message may be received through the proxy server. The reception SIP wireless LAN terminal may transmit “180 Ringing” and “200 OK” messages to the SIP server.

Then, the SIP server may transmit the “180 Ringing” and “200 OK” messages, which are received from the reception SIP wireless LAN terminal, to the transmission SIP wireless LAN terminal. At this time, the SIP server may processe the “180 Ringing” and “200 OK” messages received from the reception SIP wireless LAN terminal, and transmit them to the transmission SIP wireless LAN terminal. However, this process will be no longer described.

The transmission SIP wireless LAN terminal may directly transmit an ACK message to the reception SIP server without the proxy server.

The transmission and reception SIP wireless LAN terminals may set up the call through the message transceiving processes as mentioned above, thereby performing media communication.

Thus, as for a process where the call may be set up between the transmission and reception SIP wireless LAN terminals and disconnected for the media communication, the transmission or reception SIP wireless LAN terminal may transmit a “BYE” message to the SIP server.

Then, the SIP server may transmit the “BYE” message, which may be received from the transmission or reception SIP wireless LAN terminal, to the reception or transmission SIP wireless LAN terminal.

Subsequently, the corresponding transmission or reception SIP wireless LAN terminal receiving the “BYE” message may transmit a “200 OK” message, an acknowledgement message to the “BYE” message, to the SIP server and may simultaneously disconnect the call.

Further, the SIP server receiving the “200 OK” message to the “BYE” message may transmit the received “200 OK” message to the transmission or reception SIP wireless LAN terminal transmitting the “BYE” message, and may simultaneously disconnect the call of the transmission or reception SIP wireless LAN terminal transmitting the “BYE” message.

However, the above described conventional SIP-based wireless LAN communication system between the terminals may have only the header with the release process information corresponding to the “BYE” and “200 OK” messages. The SIP-based wireless LAN communication system did not check speech quality or call status in the network and terminals based on the release messages (e.g., BYE and 200OK). Although SIP-based wireless LAN communication system was discussed in detail above, the foregoing deficiencies may also arise in other communication systems and/or protocols including but not limited to H.323 and MGCP (media gateway control protocol).

### SUMMARY OF THE INVENTION

A communication terminal includes a controller to, when a call set up between the communication terminal and a second communication terminal in an internet protocol network is released, encapsulate in a call release request message call status information relating to at least one status of the call and transmit the call release request message. The communication terminal further includes an output element coupled to the controller to transmit the call release request message. The call release request message includes the call status information and information indicating the call release.

### BRIEF DESCRIPTION OF THE DRAWINGS

The above and other objects, features and advantages of the present invention will become more apparent from the following detailed description when taken in conjunction with the accompanying drawings in which:

FIG. 1 shows the configuration of a SIP-based wireless LAN system according to an exemplary embodiment of the present invention;

FIG. 2 is a functional block diagram showing the detailed configuration of a SIP-based wireless LAN system according to an exemplary embodiment of the present invention;

FIG. 3 is a flow chart showing a method for managing a network state using call release request/response messages in a SIP-based wireless LAN system according to an exemplary embodiment of the present invention;

FIG. 4 is a flow chart showing the detailed operation of the step of transmitting a call release request message;

FIG. 5 is a flow chart showing the detailed operation of the step of transmitting a call release response message;

FIG. 6 is a functional block diagram showing a SIP-based wireless LAN system according to another embodiment of the present invention; and

FIG. 7 is a functional block diagram showing a SIP-based wireless LAN system according to another exemplary embodiment of the present invention.

### DETAILED DESCRIPTION OF THE INVENTION

Exemplary embodiments of the present invention will now be described in detail with reference to the annexed drawings. In the drawings, the same or similar elements are denoted by the same reference numerals even though they may be depicted in different drawings. In the following description, a detailed description of known functions and configurations incorporated herein has been omitted for clarity and conciseness.

The session initiation protocol (SIP)-based wireless local area network (LAN) system according to the first embodiment of the present invention is described hereinafter with reference to the accompanying drawings. It should be understood by those skilled in the art that the following system is merely referred to describe the present invention and thus the present invention is not limited to such a system. Although an illustration of the present invention is made in reference to a system using SIP, the present invention may also be applied to other systems and/or protocols including but not limited to H.323 and MGCP.

In general, when intending to perform media communication on a reception SIP wireless LAN terminal, a transmission SIP wireless LAN terminal may recognize an Internet protocol (IP) address of the reception SIP wireless LAN terminal. However, if not so, the transmission SIP wireless LAN terminal may gain access to a SIP server that may store the IP address of the reception SIP wireless LAN terminal to thereby perform the media communication with the reception SIP wireless LAN terminal. Wireless LAN terminals are referred to throughout the disclosure, but however, the present invention is also applicable to communication between wired terminals and other types (e.g., WAN, MAN) of wireless terminals. Terminals referred to throughout the disclosure may be of any type of terminals including but not limited to mobile, or fixed, phones, computers, and PDAs, and each has a controller (e.g., transmission controller and reception contoller) and an output element coupled to the controller, which may be any output element for transmitting a message including but not limited to, for example, an output terminal/node/conductor for wired terminals and an antenna for wireless terminals.

Thus, the transmission and reception SIP wireless LAN terminals gain access to the SIP server to thereby perform the media communication. At this time, a call setup process between the transmission and reception SIP wireless LAN terminals is disclosed in the prior art.

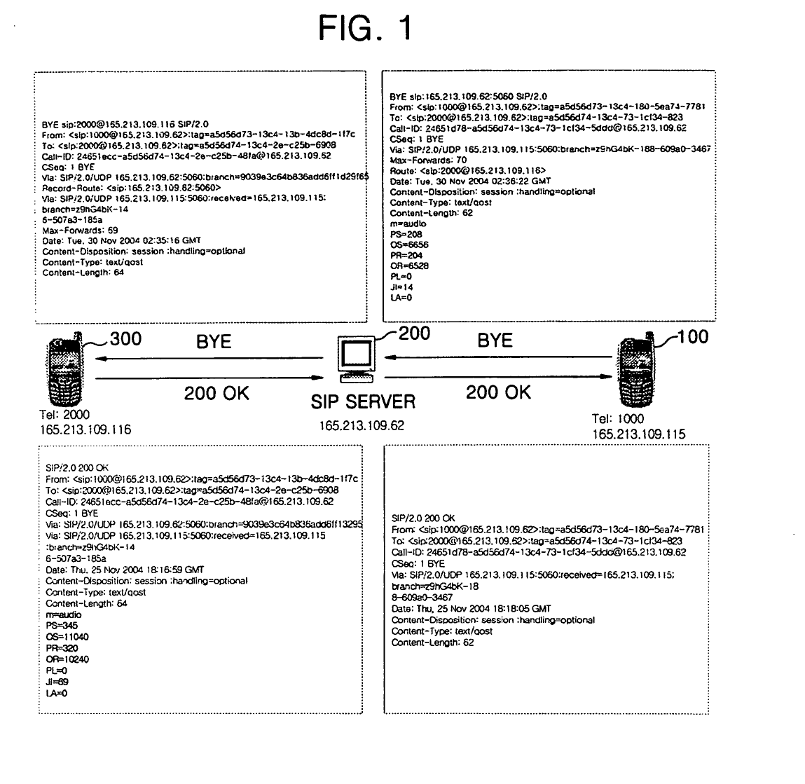

FIG. 1 shows the configuration of a SIP-based wireless LAN system according to an exemplary embodiment of the present invention. The SIP-based wireless LAN system may be composed of a transmission SIP wireless LAN terminal 100, a SIP server 200 and a reception SIP wireless LAN terminal 300. Here, packet data transmission/reception information a or b may be encapsulated in a “BODY” of a “BYE” or “200 OK” message.

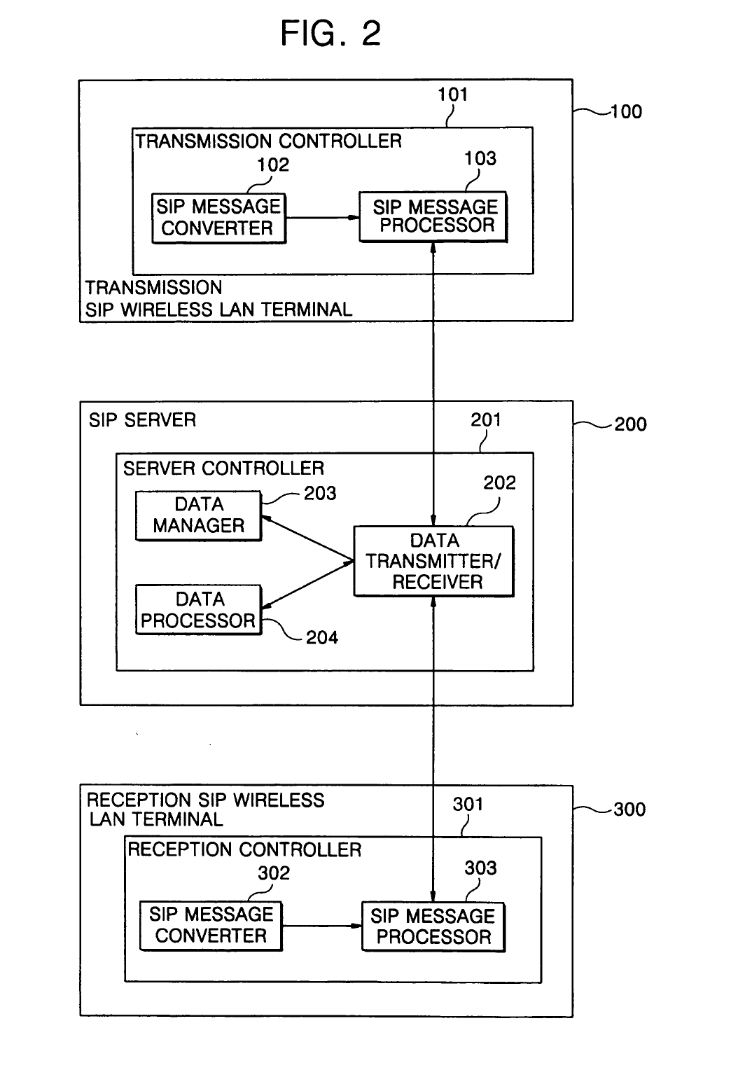

FIG. 2 is a functional block diagram showing the detailed configuration of a SIP-based wireless LAN system according to an exemplary embodiment of the present invention. A transmission SIP wireless LAN terminal 100 may have a transmission controller 101 that may encapsulate packet data transmission/reception information a relating to a call status in a “BODY” of a “BYE” message and transmit the “BYE” message to a SIP server 200 and an output element (any output element for transmitting a message including but not limited to, for example, an output terminal/node/conductor for wired terminals and an antenna for wireless terminals) coupled to the controller to transmit the “BYE” message. Each message (e.g., “BYE” or “200 OK” ), referred to throughout the disclosure may comprise the call status information and information indicating the call release. The transmission controller 101 of the transmission SIP wireless LAN terminal 100 may include a SIP message converter 102 and a SIP message processor 103.

At this time, the packet data transmission/reception information a relating to at least one status of the call includes information relating to at least one of a media type m, the number of packets PS that are transmitted by the corresponding wireless LAN terminal, a total octet value OS of the packets that are transmitted by the corresponding wireless LAN terminal, the number of packets PR that are received by the corresponding wireless LAN terminal, a total octet value OR of the packets that are received by the corresponding wireless LAN terminal, a packet loss PL, and jitter buffer information JI.

A media type m, as referred to throughout the disclosure can be any media type including but not limited to audio and video. A number of packets PS that are transmitted by a corresponding wireless LAN terminal, as referred to throughout the disclosure, can be a total number of packets that are transmitted by the corresponding wireless LAN terminal during any period of the call including but not limited to the entire call. A total octet value OS of the packets that are transmitted by a corresponding wireless LAN terminal, as referred to throughout the disclosure, can mean a total number of bytes of information transmitted by the corresponding wireless LAN terminal during any period of the call including but not limited to the entire call.

A number of packets PR that are received by a corresponding wireless LAN terminal, as referred to throughout the disclosure, can mean a total number of packets received by the corresponding wireless LAN terminal during any period of the call including but not limited to the entire call. A total octet value OR of the packets that is received by a corresponding wireless LAN terminal can mean a total number of bytes of information transmitted by the corresponding wireless LAN terminal during any period of the call including but not limited to the entire call. A packet loss PL, as referred to throughout the disclosure, can mean a total packet loss during any period of the call the call including but not limited to the entire call. Jitter buffer information, as referred to throughout the disclosure, can mean any information related to a jitter buffer of the corresponding wireless LAN terminal including but not limited to a size of the jitter buffer.

The SIP message converter 102 in the transmission controller 101 according to an exemplary embodiment of the invention may encapsulate the packet data transmission/reception information a in the “BODY” of the “BYE” message and then convert the “BYE” message.

The SIP message processor 103 in the transmission controller 101 according to an exemplary embodiment of the invention may transmit the “BYE” message, which may be converted by the SIP message converter 102, to the SIP server 200.

A reception SIP wireless LAN terminal 300 according to an exemplary embodiment of the invention may have a reception controller 301 that, when receiving the “BYE” message transmitted from the SIP server 200 when a call is released, may encapsulate packet data transmission/reception information b in a “BODY” of a “200 OK” message and may transmit the “200 OK” message to a SIP server 200 and an output element (any output element for transmitting a message including but not limited to, for example, an output terminal/node/conductor for wired terminals and an antenna for wireless terminals) coupled to he controller to transmit the “200 OK” message. The reception controller 301 of the reception SIP wireless LAN terminal 300 may include a SIP message converter 302 and a SIP message processor 303. An encapsulation of packet data transmission/reception information in a body of a message, as referred to throughout the disclosure, may also be done in the header of the message.

The SIP message converter 302 in the reception controller 301 according to an exemplary embodiment of the invention may encapsulate the packet data transmission/reception information b in the “BODY” of the “200 OK” message and convert the “200 OK” message. At this time, the packet data transmission/reception information b may include information relating to at least one of a media type m (e.g., audio or video), the number of packets PS that are transmitted by the corresponding wireless LAN terminal (e.g., the total number of packets transmitted by the corresponding wireless LAN terminal during the entire call), a total octet value OS of the packets that are transmitted by the corresponding wireless LAN terminal (e.g., a total number of packets transmitted by the corresponding wireless LAN terminal during any period of the call including but not limited to the entire call, the number of packets PR that are received by the corresponding wireless LAN terminal (e.g., the total number of packets received by the corresponding wireless LAN terminal during the entire call), a total octet value OR of the packets that are received by the corresponding wireless LAN terminal (e.g., a total number of bytes of information transmitted by the corresponding wireless LAN terminal during the entire call, a packet loss PL (e.g., a total packet loss during the entire call), and jitter buffer information JI (e.g., information related to a jitter buffer of the corresponding wireless LAN terminal).

The SIP message processor 303 in the reception controller 301 according to an exemplary embodiment of the invention may transmit the “200 OK” message, which may be converted by the SIP message converter 302, to the SIP server 200.

Further, the SIP server 200 according to an exemplary embodiment of the invention may have a server controller 201 that, when receiving the “BYE” message including the packet data transmission/reception information a from the transmission SIP wireless LAN terminal 100, may store/manage the packet data transmission/reception information a and transmit the “BYE” message from which the packet data transmission/reception information a may be removed to the reception SIP wireless LAN terminal 300, and that, when receiving the “200 OK” message including the packet data transmission/reception information b from the reception SIP wireless LAN terminal 300, may store/manage the packet data transmission/reception information b and transmit the “200 OK” message from which the packet data transmission/reception information b may be removed to the transmission SIP wireless LAN terminal 100. The server controller 201 of the SIP server 200 may include a data transmitter/receiver 202, a data manager 203, and a data processor 204.

The data transmitter/receiver 202 in the server controller 201 according to an exemplary embodiment of the invention may receive the “BYE” message including the packet data transmission/reception information a from the transmission SIP wireless LAN terminal 100 or the “200 OK” message including the packet data transmission/reception information b from the reception SIP wireless LAN terminal 300.

And the data manager 203 in the server controller 201 according to an exemplary embodiment of the invention may extract the packet data transmission/reception information a or b from the “BYE” or “200 OK” message received through the data transmitter/receiver 202, and may store/manage the extracted information.

Further, the data processor 204 in the server controller 201 according to an exemplary embodiment of the invention may remove the packet data transmission/reception information a from the “BYE” message received from the transmission SIP wireless LAN terminal 100 through the data transmitter/receiver 202 and transmit the “BYE” message from which the packet data transmission/reception information a may be removed to the reception SIP wireless LAN terminal 300, and remove the packet data transmission/reception information b from the “200 OK” message received from the reception SIP wireless LAN terminal 300 through the data transmitter/receiver 202 and transmit the “200 OK” message from which the packet data transmission/reception information b may be removed to the transmission SIP wireless LAN terminal 100. At this time, an arbitrary field of the call release request or response message (BYE or 200 OK message) may make use of a “BODY” field or a header field. The packet data transmission/reception information a or b may include at least one of the media type m, the number of packets PS that are transmitted by the corresponding wireless LAN terminal, the total octet value OS of the packets that are transmitted by the corresponding wireless LAN terminal, the number of packets PR that are received by the corresponding wireless LAN terminal, the total octet value OR of the packets that are received by the corresponding wireless LAN terminal, the packet loss PL, and the jitter buffer information JI.

Each of the aforementioned constituents will be described with focus to operations related to the present invention rather than their general functions and detailed operations.

Above all, as for an exemplary process of releasing a call between the transmission reception SIP wireless LAN terminals 100 and 300 between which the call has been set up through the SIP server 200, the SIP message converter 102 in the transmission controller 101 of the transmission SIP wireless LAN terminal 100 according to an exemplary embodiment of the invention may convert a “BYE” message after including packet data transmission/reception information a in a “BODY” of the “BYE” message. At this time, the packet data transmission/reception information a may include information relating to at least one of a media type m, the number of packets PS that are transmitted by the corresponding wireless LAN terminal, a total octet value OS of the packets that are transmitted by the corresponding wireless LAN terminal, the number of packets PR that are received by the corresponding wireless LAN terminal, a total octet value OR of the packets that are received by the corresponding wireless LAN terminal, a packet loss PL, and jitter buffer information JI.

Subsequently, the SIP message processor 103 in the transmission controller 101 of the transmission SIP wireless LAN terminal 100 according to an exemplary embodiment of the invention may transmit the “BYE” message converted by the SIP message converter 102 to the SIP server 200.

Then, the server controller 201 in the SIP server 200 according to an exemplary embodiment of the invention may store/manage the packet data transmission/reception information a when receiving the “BYE” message including the packet data transmission/reception information a from the transmission SIP wireless LAN terminal 100, and then transmit the “BYE” message from which the packet data transmission/reception information a may be removed to the reception SIP wireless LAN terminal 300.

Next, the SIP message converter 302 of the reception SIP wireless LAN terminal 300 according to an exemplary embodiment of the invention converts a “200 OK” message after including packet data transmission/reception information b in a “BODY” of the “200 OK” message.

Then, the SIP message processor 303 of the reception SIP wireless LAN terminal 300 according to an exemplary embodiment of the invention may transmit the “200 OK” message converted by the SIP message converter 302 to the SIP server 200. Thus, the call may be released between the reception SIP wireless LAN terminal 300 and the transmission SIP wireless LAN terminal 100.

Subsequently, the data transmitter/receiver 202 of the SIP server 200 according to an exemplary embodiment of the invention may receive the “200 OK” message including the packet data transmission/reception information b from the reception SIP wireless LAN terminal 300.

Then, the data manager 203 of the SIP server 200 according to an exemplary embodiment of the invention may extract the packet data transmission/reception information a and b from the “BYE” and “200 OK” messages which may be received through the data transmitter/receiver 202, and store/manage the extracted information.

Meanwhile, the data processor 204 of the SIP server 200 according to an exemplary embodiment of the invention may remove the packet data transmission/reception information b from the “200 OK” message received from the reception SIP wireless LAN terminal 300 through the data transmitter/receiver 202, and transmit the “200 OK” message from which the packet data transmission/reception information b may be removed to the corresponding transmission SIP wireless LAN terminal 100. Thus, the call may be released between the transmission SIP wireless LAN terminal 100 and the reception SIP wireless LAN terminal 300.

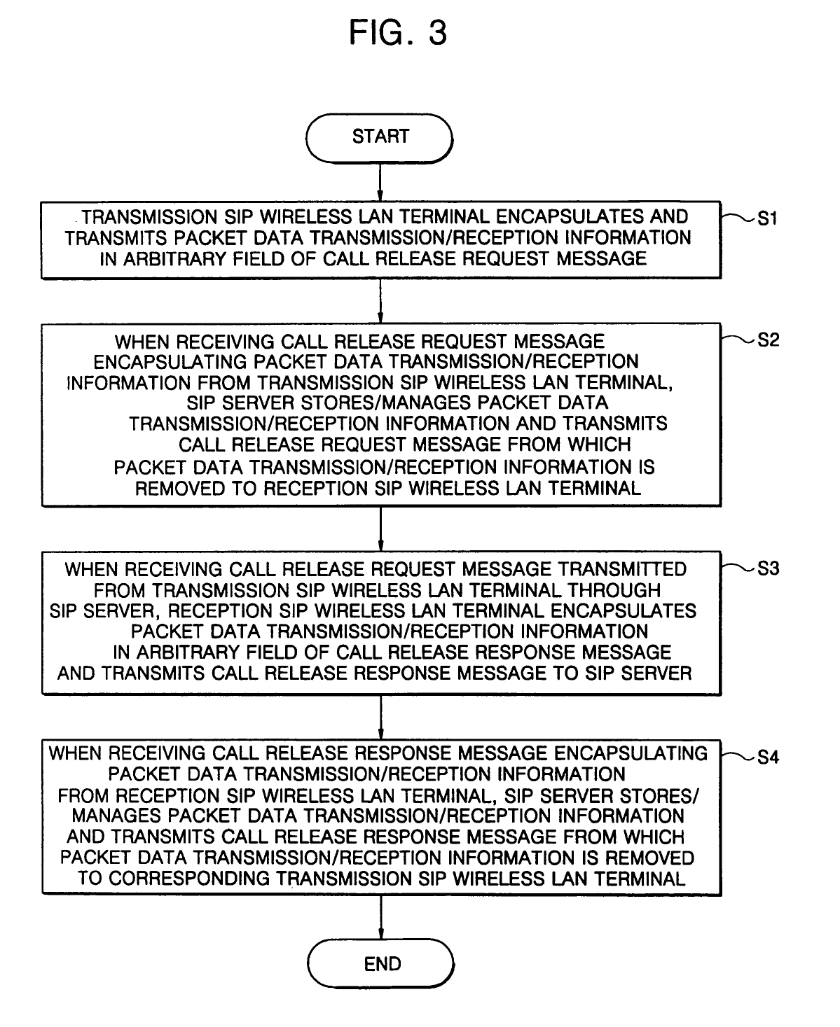

Now, an exemplary method for managing a network state using BYE/200 OK messages in a SIP-based wireless LAN system having the aforementioned configuration will be described with reference to FIG. 3.

First, the transmission SIP wireless LAN terminal 100 according to an exemplary embodiment of the invention may encapsulate packet data transmission/reception information a in an arbitrary field of a call release request (BYE) message transmitted when a call is released, and then transmit the call release request message (S1).

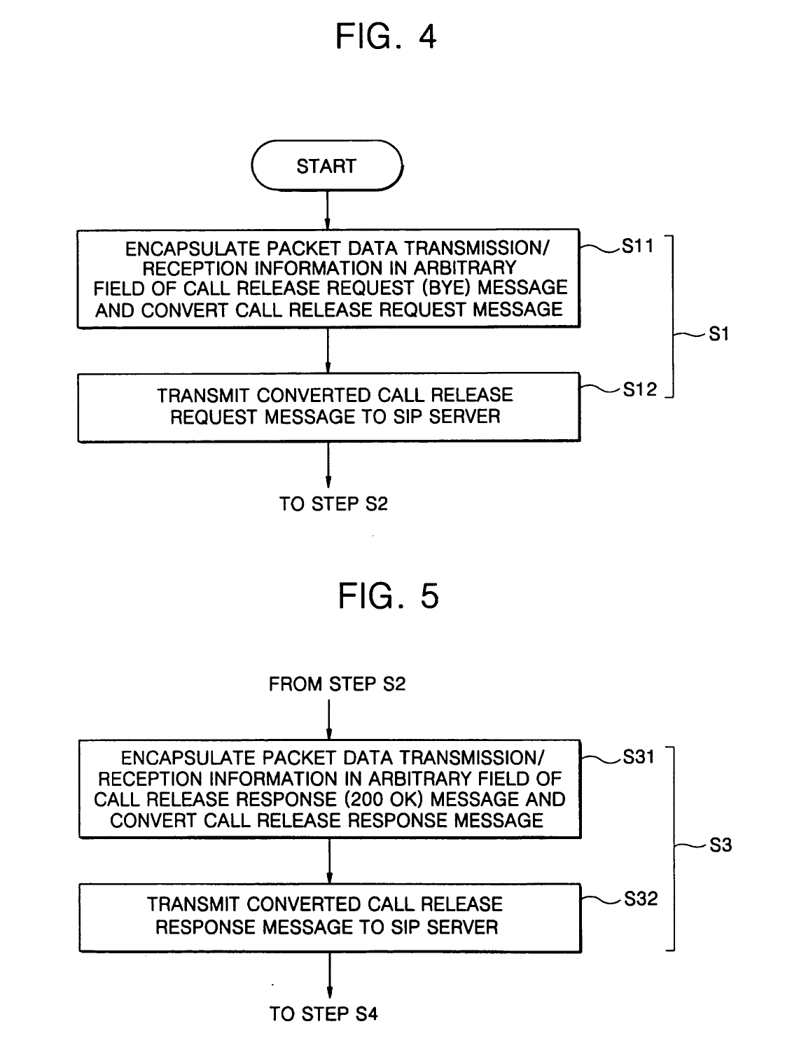

Hereinafter, the operation of step S1 according to an exemplary embodiment of the invention will be described in more detail with reference to FIG. 4.

The packet data transmission/reception information a may be encapsulated in the arbitrary field of the call release request (BYE) message, and then the call release request message is converted (S11).

Thereafter, the converted call release request message may be transmitted to the SIP server 200 (S12).

Subsequently, when receiving the call release request message encapsulating the packet data transmission/reception information a from the transmission SIP wireless LAN terminal 100 according to an exemplary embodiment of the invention, the SIP server 200 may store/manage the received packet data transmission/reception information a and transmit the call release request message from which the packet data transmission/reception information a may be removed to the reception SIP wireless LAN terminal 300 (S2).

Then, when receiving the call release request message transmitted from the transmission SIP wireless LAN terminal 100 through the SIP server 200 according to an exemplary embodiment of the invention, the reception SIP wireless LAN terminal 300 may encapsulate packet data transmission/reception information b in an arbitrary field of a call release response (200 OK) message and transmit the call release response message to the SIP server 200 (S3).

Hereinafter, the operation of step S3 according to an exemplary embodiment of the invention will be described in more detail with reference to FIG. 5.

The call release response (200 OK) message may be converted after the packet data transmission/reception information b may be encapsulated in the arbitrary field of the call release response message (S31).

Thereafter, the converted call release response message may be transmitted to the SIP server (S32).

Subsequently, when receiving the call release response message encapsulating the packet data transmission/reception information b from the reception SIP wireless LAN terminal 300 according to an exemplary embodiment of the invention, the SIP server 200 may store/manage the received packet data transmission/reception information b and transmit the call release response message from which the packet data transmission/reception information b may be removed to the transmission SIP wireless LAN terminal 100 (S4).

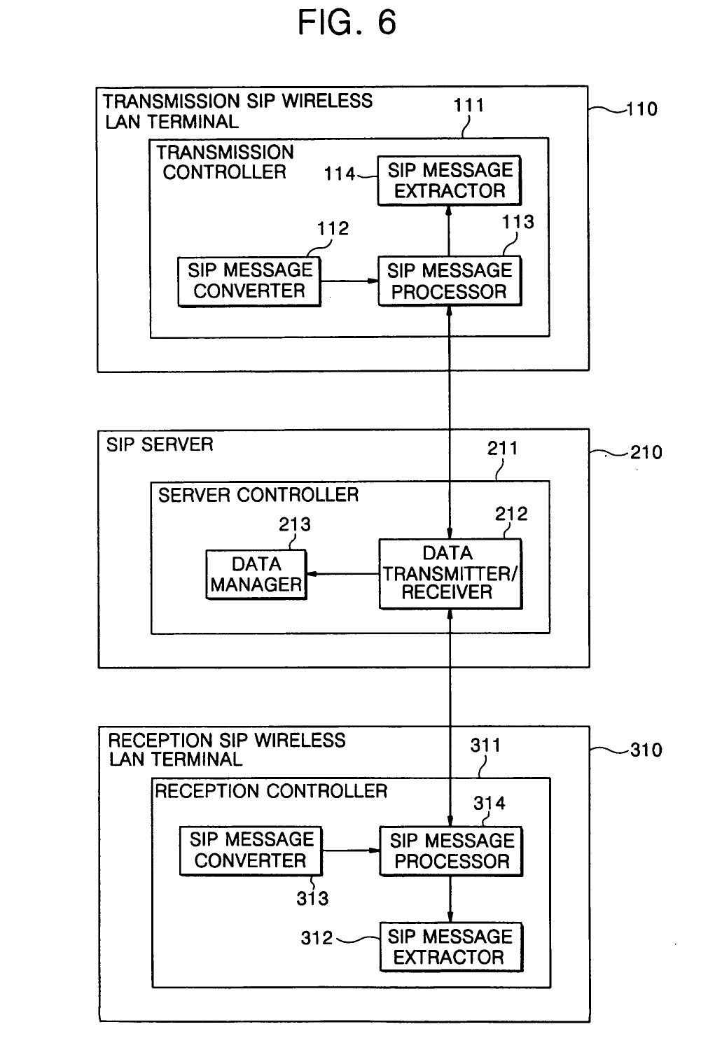

FIG. 6 is a functional block diagram showing the detailed configuration of a SIP-based wireless LAN system according to another exemplary embodiment of the present invention.

The SIP-based wireless LAN system may include a transmission SIP wireless LAN terminal 110 according to an exemplary embodiment of the invention, a SIP server 210 and a reception SIP wireless LAN terminal 310.

The transmission SIP wireless LAN terminal 110 according to an exemplary embodiment of the invention may have a transmission controller 111 that, when releasing a call from the reception SIP wireless LAN terminal 310 during communication, may encapsulate packet data transmission/reception information a in an arbitrary field of a call release request (BYE) message, transmit the call release request message to the SIP server 210, and receive a call release response (200 OK) message encapsulating packet data transmission/reception information b from the SIP server 210. The transmission controller 111 of the transmission SIP wireless LAN terminal 110 may include a SIP message converter 112, a SIP message processor 113 and a SIP message extractor 114.

The SIP message converter 112 in the transmission controller 111 according to an exemplary embodiment of the invention may encapsulate the packet data transmission/reception information a in the arbitrary field of the call release request (BYE) message.

The SIP message processor 113 in the transmission controller 111 according to an exemplary embodiment of the invention may transmit the call release request message converted by the SIP message converter 112 to the SIP server 210.

Further, when receiving the call release response (200 OK) message in an arbitrary field of which the packet data transmission/reception information b may be encapsulated, according to an exemplary embodiment of the invention, the SIP message extractor 114 in the transmission controller 111 may extract the packet data transmission/reception information b. At this time, the arbitrary field of the call release request (BYE) or response (200 OK) message may make use of a “BODY” field, and the packet data transmission/reception information a or b includes information relating to at least one of a media type m, the number of packets PS that are transmitted by the corresponding wireless LAN terminal, a total octet value OS of the packets that are transmitted by the corresponding wireless LAN terminal, the number of packets PR that are received by the corresponding wireless LAN terminal, a total octet value OR of the packets that are received by the corresponding wireless LAN terminal, a packet loss PL, and jitter buffer information JI. Use of an arbitrary field of a message, as referred to throughout the disclosure, means use of any filed of the message including the header and the body fields.

The reception SIP wireless LAN terminal 310 according to an exemplary embodiment of the invention may have a reception controller 311 that, when releasing the call from the transmission SIP wireless LAN terminal 110 during communication, may receive the call release request (BYE) message in the arbitrary field of which the packet data transmission/reception information a may be encapsulated, and transmit the call release response (200 OK) message encapsulating the packet data transmission/reception information b to the SIP server 210. The reception controller 311 of the reception SIP wireless LAN terminal 310 may include a SIP message extractor 312, a SIP message converter 313, and a SIP message processor 314.

When receiving the call release request (BYE) message in the arbitrary field of which the packet data transmission/reception information a may be encapsulated according to an exemplary embodiment of the invention, the SIP message extractor 312 in the reception controller 311 may extract the packet data transmission/reception information a.

And the SIP message converter 313 in the reception controller 311 according to an exemplary embodiment of the invention may encapsulate the packet data transmission/reception information b in the arbitrary field of the call release response (200 OK) message and convert the call release response message.

Further, the SIP message processor 314 in the reception controller 311 according to an exemplary embodiment of the invention may transmit the call release response message converted by the SIP message converter 313 to the SIP server 210. At this time, the arbitrary field of the call release request (BYE) or response (200 OK) message may make use of the “BODY” field, and the packet data transmission/reception information a or b may include information relating to at least one of a media type m, the number of packets PS that are transmitted by the corresponding wireless LAN terminal, a total octet value OS of the packets that are transmitted by the corresponding wireless LAN terminal, the number of packets PR that are received by the corresponding wireless LAN terminal, a total octet value OR of the packets that are received by the corresponding wireless LAN terminal, a packet loss PL, and jitter buffer information JI.

The SIP server 210 according to an exemplary embodiment of the invention may have a server controller 211 that, when receiving the call release request message encapsulating the packet data transmission/reception information a from the transmission SIP wireless LAN terminal 110, may store/manage the packet data transmission/reception information a and transmit the call release request message to the reception SIP wireless LAN terminal 310, and that, when receiving the call release response message encapsulating the packet data transmission/reception information b from the reception SIP wireless LAN terminal 310, may store/manage the packet data transmission/reception information b and transmit the call release response message to the transmission SIP wireless LAN terminal 110. The server controller 211 of the SIP server 210 may include a data transmitter/receiver 212 and a data manager 213.

The data transmitter/receiver 212 in the server controller 211 according to an exemplary embodiment of the invention may receive the call release request message encapsulating the packet data transmission/reception information a from the transmission SIP wireless LAN terminal 110 or the call release response message encapsulating the packet data transmission/reception information b from the reception SIP wireless LAN terminal 310.

And the data manager 213 of the server controller 211 according to an exemplary embodiment of the invention may extract the packet data transmission/reception information a or b from the call release request or response message received through the data transmitter/receiver 212, and store/manage the extracted information. At this time, the arbitrary field of the call release request or response (BYE or 200 OK) message may make use of the “BODY” field. The packet data transmission/reception information a or b may include at least one of the media type m, the number of packets PS that are transmitted by the corresponding wireless LAN terminal, the total octet value OS of the packets that are transmitted by the corresponding wireless LAN terminal, the number of packets PR that are received by the corresponding wireless LAN terminal, the total octet value OR of the packets that are received by the corresponding wireless LAN terminal, the packet loss PL, and the jitter buffer information JI.

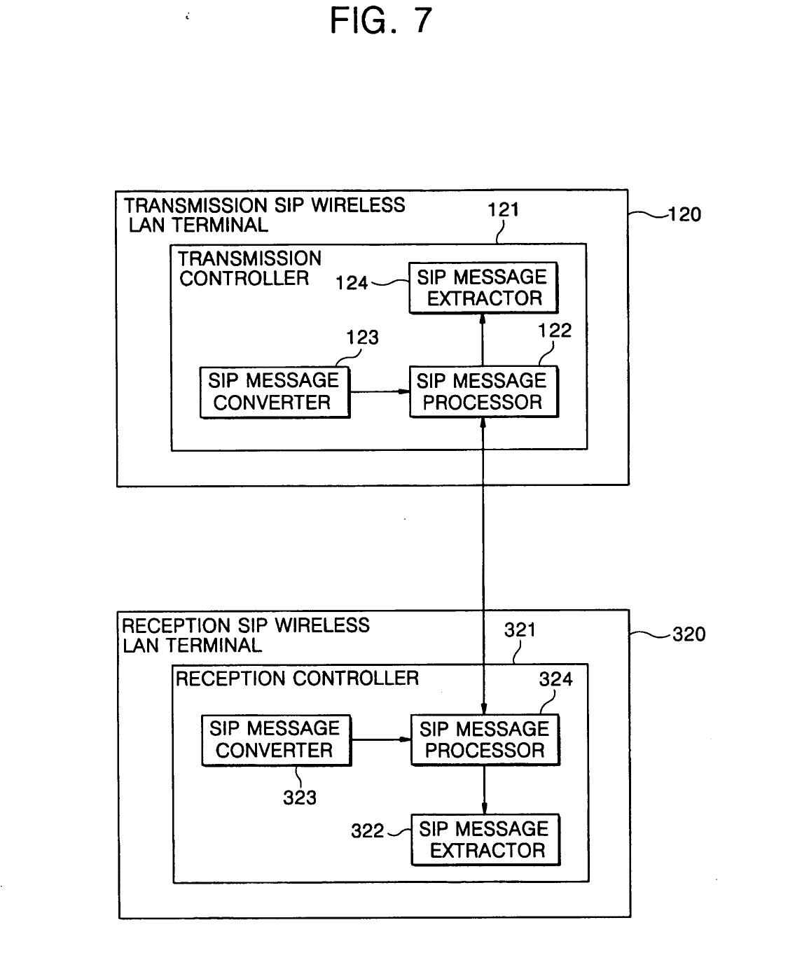

FIG. 7 is a functional block diagram showing a SIP-based wireless LAN system according to another exemplary embodiment of the present invention.

The SIP-based wireless LAN system according to an exemplary embodiment of the invention may be composed of a transmission SIP wireless LAN terminal 120 and a reception SIP wireless LAN terminal 320.

The transmission SIP wireless LAN terminal 120 according to an exemplary embodiment of the invention may have a transmission controller 121 that, when releasing a call from the reception SIP wireless LAN terminal 320 during communication, may encapsulate packet data transmission/reception information a in an arbitrary field of a call release request (BYE) message, transmit the call release request message to the reception SIP wireless LAN terminal 320, and receive a call release response (200 OK) message encapsulating packet data transmission/reception information b from the reception SIP wireless LAN terminal 320. The transmission controller 121 of the transmission SIP wireless LAN terminal 120 may include a SIP message converter 123, a SIP message processor 122 and a SIP message extractor 124.

The SIP message converter 123 in the transmission controller 131 according to an exemplary embodiment of the invention may encapsulate the packet data transmission/reception information a in the arbitrary field of the call release request (BYE) message and convert the call release request message.

And the SIP message processor 122 in the transmission controller 121 according to an exemplary embodiment of the invention may transmit the call release request message converted by the SIP message converter 123 to the reception SIP wireless LAN terminal 320.

Further, when receiving the call release response (200 OK) message in an arbitrary field of which the packet data transmission/reception information b may be encapsulated, according to an exemplary embodiment of the invention, the SIP message extractor 124 in the transmission controller 121 may extract the packet data transmission/reception information b. At this time, the arbitrary field of the call release request (BYE) or response (200 OK) message may make use of a “BODY” field, and the packet data transmission/reception information a or b may includes information relating to at least one of a media type m, the number of packets PS that are transmitted by the corresponding wireless LAN terminal, a total octet value OS of the packets that are transmitted by the corresponding wireless LAN terminal, the number of packets PR that are received by the corresponding wireless LAN terminal, a total octet value OR of the packets that are received by the corresponding wireless LAN terminal, a packet loss PL, and jitter buffer information JI.

The reception SIP wireless LAN terminal 320 according to an exemplary embodiment of the invention has a reception controller 321 that, when receiving the call release request (BYE) message in the arbitrary field of which the packet data transmission/reception information a is encapsulated from the transmission SIP wireless LAN terminal 120, transmits the call release response (200 OK) message encapsulating the packet data transmission/reception information b to the transmission SIP wireless LAN terminal 120. The reception controller 321 of the reception SIP wireless LAN terminal 320 includes a SIP message extractor 322, a SIP message converter 323, and a SIP message processor 324.

When receiving the call release request message in the arbitrary field of which the packet data transmission/reception information a is encapsulated from the transmission SIP wireless LAN terminal 120, according to an exemplary embodiment of the invention, the SIP message extractor 322 in the reception controller 321 extracts the packet data transmission/reception information a.

The SIP message converter 323 in the reception controller 321 according to an exemplary embodiment of the invention encapsulates the packet data transmission/reception information b in the arbitrary field of the call release response message and converts the call release response message.

Further, the SIP message processor 324 in the reception controller 321 according to an exemplary embodiment of the invention transmits the call release response message converted by the SIP message converter 323 to the transmission SIP wireless LAN terminal 120.

At this time, the arbitrary field of the call release request or response message makes use of the “BODY” field, and the packet data transmission/reception information a or b includes information relating to at least one of a media type m, the number of packets PS that are transmitted by the corresponding wireless LAN terminal, a total octet value OS of the packets that are transmitted by the corresponding wireless LAN terminal, the number of packets PR that are received by the corresponding wireless LAN terminal, a total octet value OR of the packets that are received by the corresponding wireless LAN terminal, a packet loss PL, and jitter buffer information JI.

According to the method for managing the network state using the call release request/response message in the SIP-based communication system as mentioned above, according to an exemplary embodiment of the invention, the wireless LAN terminal of the SIP-based communication system may encapsulate the packet data transmission/reception information in the call release request/response message that may be transmitted/received in order to release the call during communication and transmit the call release request/response message to the SIP server. As to the packet data transmission/reception information a or b, referred to throughout the disclosure, such information may be used for any purpose including but not limited to determining the network state during the call, the quality of the communication during the call (e.g., speech/audio quality and video quality) and billing (e.g., calculating the total fee to be charged/allocated to each of the wireless LAN terminals). The information may be used by an administrator for the foregoing purposes.

While the present invention has been described with reference to exemplary embodiments thereof, it will be understood by those skilled in the art that various changes in form and detail may be made therein without departing from the scope of the present invention as defined by the following claims.

What is claimed is:

1. A communication terminal comprising:
a controller adapted to, when a call set up between the communication terminal and a second communication terminal in an internet protocol network is released, encapsulate in a call release request message call status information relating to at least one status of the call and transmit the call release request message, the call release request message comprising the call status information and information indicating the call release; and
an output element coupled to the controller to transmit the call release request message.

2. The communication terminal of claim 1, wherein the call status information includes information relating to at least one of a media type, a total number of packets transmitted by the first communication terminal during the call, a total number of packets received by the first communication terminal during the call, a total packet loss during the call and a jitter buffer.

3. The communication terminal of claim 1, wherein the call status information includes information relating to a total number of bytes of information transmitted by the first communication terminal during the call.

4. The communication terminal of claim 1, wherein the call status information includes information relating to a total number of bytes of information received by the first communication terminal during the call.

5. The communication terminal of claim 1, wherein the call is set up based on Session Initiation Protocol (SIP).

6. The communication terminal of claim 1, wherein the controller comprises:
a converter to encapsulate the call status information in the call release request message and convert the call release request message; and
a processor to transmit the call release request message converted by the converter.

7. The communication terminal of claim 6, wherein the controller further comprises:
an extractor to, when receiving from the second communication terminal a call release response message comprising call status information relating to at least one status of the call, extract the call status information from the second communication terminal, the call release response message comprising the call status information from the second communication terminal and information indicating the call release.

8. A method comprising the steps of:
encapsulating in a call release request message, when a call set up between a first communication terminal and a second communication terminal in an internet protocol network is released, call status information relating to at least one status of the call; and
transmitting the call release request message, the call release request message comprising the call status information and information indicating the call release.

9. The method of claim 8, wherein the call status information includes information relating to at least one of a media type, a total number of packets transmitted by the first communication terminal during the call, a total number of packets received by the first communication terminal during the call, a total packet loss during the call and a jitter buffer.

10. The method of claim 8, wherein the call status information includes information relating to a total number of bytes of information transmitted by the first communication terminal during the call.

11. The method of claim 8, wherein the call status information includes information relating to a total number of bytes of information received by the first communication terminal during the call.

12. The method of claim 8, wherein the call is set up based on Session Initiation Protocol (SIP).

13. The method of claim 8, further comprising the step of extracting, when receiving from the second communication terminal a call release response message comprising call status information relating to at least one status of the call, the call status information from the second communication terminal, the call release request message comprising the call status information from the second communication terminal and information indicating the call release.

14. A method comprising the steps of:
receiving, when a call set up between a first communication terminal and a second communication terminal in an internet protocol network is released, a call release request message comprising call status information relating to at least one status of the call and information indicating the call release; and
extracting the call status information.

15. The method of claim 14, wherein the call status information includes information relating to at least one of a media type, a total number of packets transmitted by the first communication terminal during the call, a total number of packets received by the first communication terminal during the call, a total packet loss during the call and a jitter buffer.

16. The method of claim 14, wherein the call status information includes information relating to a total number of bytes of information transmitted by the first communication terminal during the call.

17. The method of claim 14, wherein the call status information includes information relating to a total number of bytes of information received by the first communication terminal during the call.

18. The method of claim 14, wherein the call is set up based on Session Initiation Protocol (SIP).

19. The method of claim 14, further comprising the steps of:
removing from the call release request message the call status information; and
transmitting to a communication terminal the call release request message without the call status information.

20. The method of claim 14, further comprising the step of receiving a call release response message comprising call status information relating to at least one status of the call and information indicating the call release and transmitted from the second communication terminal in response to the call release request message.
